(19) United States
(12) Patent Application Publication
(10) Pub. No.: US 2015/0301595 A1
(43) Pub. Date: Oct. 22, 2015

(54) ELECTRONIC APPARATUS AND EYE-GAZE INPUT METHOD

(71) Applicant: KYOCERA Corporation, Fishimi-ku, Kyoto (JP)

(72) Inventor: Yasuhiro MIKI, Ikoma-shi, Nara (JP)

(21) Appl. No.: 14/439,516

(22) PCT Filed: Oct. 29, 2013
(86) PCT No.: PCT/JP2013/079194

§ 371 Date: Apr. 29, 2015

(30) Foreign Application Priority Data
Oct. 29, 2012 (JP) 2012-237400

(51) Int. Cl. G06F 3/01; G06F 3/0484

(52) U.S. Cl. CPC G06F 3/013; G06F 3/04847; G06F 3/04842

(57) ABSTRACT

A mobile phone 10 comprises a display 14 that displays objects such as an icon, and can detect an eye-gaze input of a user. Furthermore, if an eye-gaze input to an object is performed, an operation relevant to the object is performed. When receiving a new-arrival mail, for example, a mail icon (96a) is displayed on the display 14. At this time, in the mobile phone 10, a user operation for performing a mail function is forecasted and responsivity of an eye-gaze input to the mail icon is improved.

### FIELD OF ART

The present invention relates to an electronic apparatus and an eye-gaze input method, and more specifically, an electronic apparatus that detects an eye-gaze input, and an eye-gaze input method. cl BACKGROUND ART

A data input device, for example displays an input data group of a menu, a keyboard, etc. on a display, and images an eye portion of a user of the device with a camera, and determines a direction of an eye-gaze of the user in an imaged image, and determines input data located in the direction of the eye-gaze, and outputs determined input data to external equipment, etc.

Furthermore, an eye-gaze detection device detects an eye-gaze of a subject by detecting a center of a pupil and a corneal reflex point of the subject from an imaged image.

Furthermore, a camera with eye-gaze detection function is provided with a plurality of focal detection areas in an observation screen in a view finder. Furthermore, this camera can detect an eye-gaze of an imaging person, and an eye-gaze area is set to each of the plurality of focal detection areas. Therefore, the imaging person can focus a main imaging subject by turning the eye-gaze to an arbitrary eye-gaze area.

### SUMMARY OF THE INVENTION

However, an eye-gaze input device has a tendency that the device becomes larger in proportion to a distance between a sensor and an eyeball. Therefore, if considering it is mounted on a small electronic apparatus such as a mobile terminal, for example, because the above-mentioned data input device or an eye-gaze detection device is large, not appropriate.

Furthermore, in the above-mentioned camera with eye-gaze detection function, a cursor that is displayed on a display is moved based on an image that images a pupa of the eye of the imaging person close to a window such as a finder, and therefore, it is possible to detect an eye-gaze only in a limited use situation that the display is seen through the window. Furthermore, in the camera with eye-gaze detection function, it is thinkable that operation keys are displayed on the observation screen such that an operation other than focus in imaging can also be performed by the eye-gaze. However, since a size of the eye-gaze area is decided in advance, it is hard to adjust a size for each operation key and arrangement arbitrarily in a case where the operation keys are displayed. Therefore, it is impossible to display the operation keys by taking operability of a user into consideration.

Therefore, it is a primary object to provide a novel electronic apparatus and eye-gaze input method.

It is another object of the invention to provide an electronic apparatus and eye-gaze input method, capable of improving operability of an eye-gaze input.

A first aspect according to the present invention is an electronic apparatus that has a display module operable to display a plurality of objects, and detects an eye-gaze input to the plurality of objects, and performs an operation relevant to an object that the eye-gaze input is detected, characterized by comprising: a forecast module operable to forecast a next user operation when an event occurs; and an improvement module operable to improve responsivity of the eye-gaze input to the object for performing the next user operation that is forecasted by the forecast module.

A second aspect according to the present invention is an eye-gaze input method in an electronic apparatus that has a display module operable to display a plurality of objects, and detects an eye-gaze input to the plurality of objects, and performs an operation relevant to an object that the eye-gaze input is detected, a processor performs steps of: forecasting a next user operation when an event occurs; and improving responsivity of the eye-gaze input to the object for performing the next user operation that is forecasted b the forecasting step.

According to the present invention, operability of an eye-gaze input can be improved.

The above described objects and other objects, features, aspects and advantages of the invention will become more apparent from the following detailed description of the invention when taken in conjunction with the accompanying drawings.

### BRIEF DESCRIPTION OF THE DRAWINGS

FIG. 1 is an appearance view showing a mobile phone of an embodiment according to the present invention.

FIG. 2 is a block diagram showing electric structure of the mobile phone shown in FIG. 1.

FIG. 3 is an illustration view showing an example of a gaze point that is detected on a display surface of a display shown in FIG. 1.

FIG. 4 is an illustration view showing an example of a pupil and a Purkinje image that are imaged by an infrared camera shown in FIG. 1.

FIG. 5 illustrates an example of an eye-gaze vector calculated by a processor shown in FIG. 2, wherein FIG. 5(A) shows an example of a first center position and a second center position, and FIG. 5(B) shows an example of the eye-gaze vector.

FIG. 6 is an illustration view showing an example of objects displayed on the display shown in FIG. 1.

FIG. 7 is an illustration view showing an example of a format of an object table stored in a RAM shown in FIG. 2.

FIG. 8 is an illustration view showing an example of a memory map of the RAM shown in FIG. 2.

FIG. 9 is a flowchart showing an example of a part of eye-gaze input processing of a processor shown in FIG. 2.

FIG. 10 a flowchart showing an example of another part of the eye-gaze input processing of the processor shown in FIG. 2, following FIG. 9.

FIG. 11 is a flowchart showing an example of eye-gaze detection processing of the processor shown in FIG. 2.

FIG. 12 is an illustration view showing an example of objects in a specific example 1 displayed on the display shown in FIG. 1.

FIG. 13 illustrates another example of objects in the specific example 1 displayed on the display shown in FIG. 1, wherein FIG. 13(A) shows an example of a state where a notification icon is further displayed, and FIG. 13(B) is an illustration view showing an example of a state of a decision area while the notification icon is displayed.

FIG. 14 is a flowchart showing an example of user operation forecast processing in the specific example 1 of the processor shown in FIG. 2.

FIG. 15 is a flowchart showing an example of responsivity improvement processing in the specific example 1 of the processor shown in FIG. 2.

FIG. 16 illustrates an example of objects in a specific example 2 displayed on the display shown in FIG. 1, wherein FIG. 16(A) shows an example of a state where a scroll bar reaches a last position, and FIG. 16(B) is an illustration view showing an example of a state of a decision area while the scroll bar reaches the last position.

FIG. 17 is a flowchart showing an example of user operation forecast processing in the specific example 2 of the processor shown in FIG. 2.

FIG. 18 is a flowchart showing an example of responsivity improvement processing in the specific example 2 of the processor shown in FIG. 2.

FIG. 19 illustrates an example of objects in a specific example 3 displayed on the display shown in FIG. 1, wherein FIG. 19(A) shows an example of a state where a lock screen is displayed, and FIG. 19(B) is an illustration view showing an example of a state of a decision area while the lock screen is displayed.

FIG. 20 is an illustration view showing an example of a format of a use history table stored in the RAM shown in FIG. 2.

FIG. 21 is an illustration vie showing another example of a memory map of the RAM shown in FIG. 2.

FIG. 22 is a flowchart showing an example of use history record processing of the processor shown in FIG. 2.

FIG. 23 is a flowchart showing an example of user operation forecast processing in the specific example 3 of the processor shown in FIG. 2.

FIG. 24 is a flowchart showing an example of responsivity improvement processing in the specific example 3 of the processor shown in FIG. 2.

FIG. 25 is a flowchart showing the other example of the eye-gaze input processing of the processor shown in FIG. 2.

### FORMS FOR EMBODYING THE INVENTION

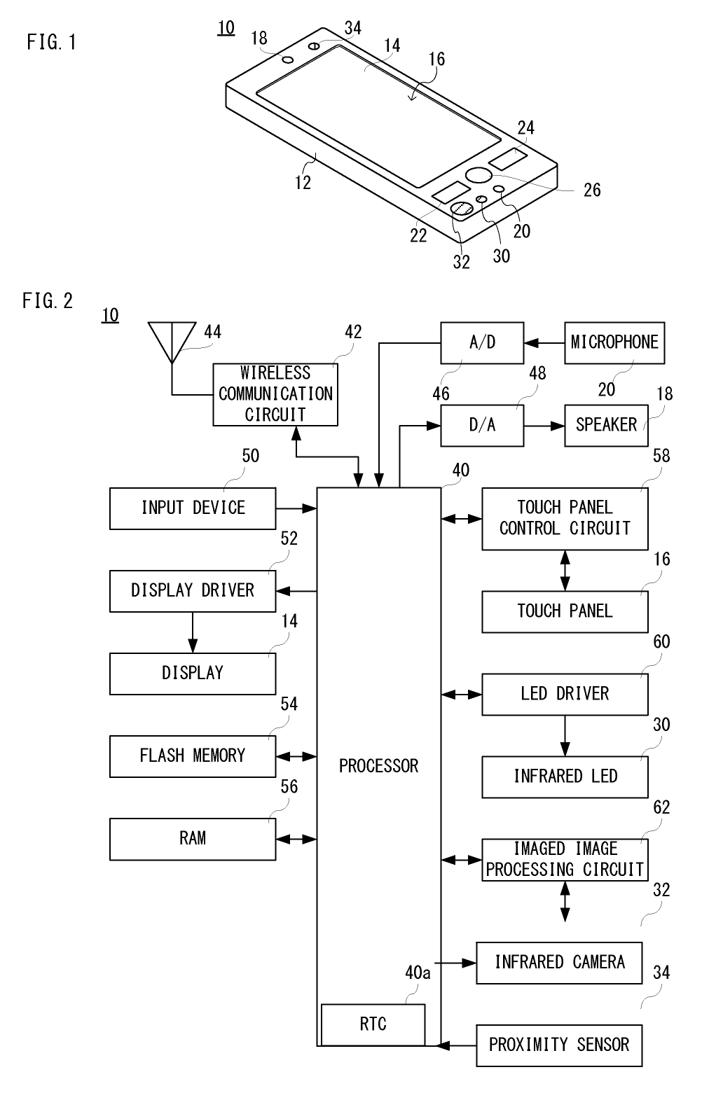

With referring to FIG. 1, a mobile phone 10 of an embodiment according to the present invention is a so-called smartphone, and includes a longitudinal flat rectangular housing 12. A display 14 that is constituted by a liquid crystal, organic EL or the like, and functions as a display module is provided on a main surface (front surface) of the housing 12. A touch panel 16 is provided on the display 14. A speaker 18 is housed in the housing 12 in one end portion of a longitudinal direction on a side of a front surface, and a microphone 20 is housed in another end portion of the longitudinal direction on the side of the front surface. As hardware keys, a call key 22, an end key 24 and a menu key 26 are provided together with the touch panel 16. Furthermore, an infrared LED 30 and an infrared camera 32 are provided in a left side of the microphone 20, and a proximity sensor 34 is provided in a right side of the speaker 18. In addition, a light emitting surface of the infrared LED 30, an imaging surface of the infrared camera 32 and a detection surface of the proximity sensor 34 are provided to be exposed from the housing 12, and remaining portions thereof are housed in the housing 12.

For example, the user can input a telephone number by making a touch operation on the touch panel 16 with respect to a dial key displayed on the display 14, and start a telephone conversation by operating the call key 22. If the end key 24 is operated, the telephone conversation can be ended. In addition, by long-depressing the end key 24, it is possible to turn on/off a power of the mobile phone 10.

Furthermore, if the menu key 26 is operated, a menu screen is displayed on the display 14. The user can perform a selection operation to a software key or a menu icon by performing a touch operation with the touch panel 16 to the software key, the menu icon, etc. being displayed on the display 14 in that state.

In addition, although a mobile phone such as a smartphone will be described as an example of an electronic apparatus in this embodiment, it is pointed out in advance that the present invention can be applied to various kinds of electronic apparatuses each comprising a display. As an example of other electronic apparatuses, arbitrary electronic apparatuses such as a feature phone, a digital book terminal, a tablet terminal, a PDA, a notebook PC, a display device, etc. can be cited, for example.

With referring to FIG. 2, the mobile phone 10 of the embodiment shown in FIG. 1 includes a processor 40, and the processor 40 is connected with the infrared camera 32, the proximity sensor 34, a wireless communication circuit 42, an ND converter 46, a D/A converter 48, an input device 50, a display driver 52, a flash memory 54, a RAM 56, a touch panel control circuit 58, an LED driver 60, an imaged image processing circuit 62, etc.

The processor 40 is called a computer or a CPU, and in charge of whole control of the mobile phone 10. An RTC 40a that is included in the processor 40, and measures the date and time. A whole or a part of a program set in advance in the flash memory 54 is, in use, developed or loaded into the RAM 56, and the processor 40 performs various kinds of processing in accordance with the program developed in the RAM 56. At this time, the RAM 56 is further used as a working area or buffer area for the processor 40.

The input device 50 includes the hardware keys (22, 24, 26) shown in FIG. 1, and functions as an operation module or an input module together with the touch panel 16 and the touch panel control circuit 58. Information (key data) of the hardware key that is operated by the user is input to the processor 40. Hereinafter, an operation with the hardware key is called “key operation”.

The wireless communication circuit 42 is a circuit for transmitting and receiving a radio wave for a telephone conversation, a mail, etc. via an antenna 44, In this embodiment, the wireless communication circuit 42 is a circuit for performing a wireless communication with a CDMA system. For example, if the user designates a telephone call (outgoing call) using the input device 50, the wireless communication circuit 42 performs telephone call processing under instructions from the processor 40 and outputs a telephone call signal via the antenna 44. The telephone call signal is transmitted to a telephone at the other end of line through a base station and a communication network. Then, if incoming call processing is performed in the telephone at the other end of line, a communication-capable state is established and the processor 40 performs the telephone conversation processing.

The microphone 20 shown in FIG. 1 is connected to the A/D converter 46, and a voice signal from the microphone 20 is input to the processor 40 as digital voice data through the A/D converter 46. The speaker 18 is connected to the D/A converter 48. The D/A converter 48 converts digital voice data into a voice signal to apply to the speaker 18 via an amplifier. Therefore, a voice of the voice data is output from the speaker 18. Then, in a state where the telephone conversation processing is performed, a voice that is collected by the microphone 20 is transmitted to the telephone at the other end of line, and a voice that is collected by the telephone at the other end of line is output from the speaker 18.

In addition, the processor 40 adjusts, in response to an operation for adjusting a volume by the user, a voice volume of the voice output from the speaker 18 by controlling an amplification factor of the amplifier connected to the D/A converter 48.

The display driver 52 controls, under instructions by the processor 40, the display of the display 14 that is connected to the display driver 52. In addition, the display driver 52 includes a video memory that temporarily stores image data to be displayed. The display 14 is provided with a backlight that includes a light source of an LED or the like, for example, and the display driver 52 controls, according to the instructions from the processor 40, brightness, light-on/off of the backlight.

The touch panel 16 shown in FIG. 1 is connected to the touch panel control circuit 58, The touch panel control circuit 58 applies to the touch panel 16 a necessary voltage and so on and inputs to the processor 40 a touch start signal indicating a start of a touch by the user, a touch end signal indicating an end of a touch by the user, and coordinate data indicating a touch position. Therefore, the processor 40 can determine the user touches to which icon or key based on the coordinate data.

The touch panel 16 is a touch panel of an electrostatic capacitance system that detects a change of an electrostatic capacitance produced between a surface thereof and an object such as a finger that is in close to the surface. The touch panel 16 detects that one or more fingers are brought into contact with the touch panel 16, for example.

The touch panel control circuit 58 functions as a detection module, and detects a touch operation within a touch-effective range of the touch panel 16, and outputs coordinate data indicative of a position of the touch operation to the processor 40. The processor 40 can determine which icon or key is touched by the user based on the coordinate data that is input from the touch panel control circuit 58. The operation on the touch panel 16 is hereinafter called as “touch operation”.

In addition, a tap operation, a long-tap operation, a flick operation, a slide operation, etc. are included in the touch operation of this embodiment. In addition, for the touch panel 16, a surface-type electrostatic capacitance system may be adopted, or a resistance film system, an ultrasonic system, an infrared ray system, an electromagnetic induction system or the like may be adopted. Furthermore, a touch operation is not limited to an operation by a finger, may be performed by a stylus pen.

Although not shown, the proximity sensor 34 includes a light emitting element (infrared LED, for example) and a light receiving element (photodiode, for example). The processor 40 calculates, from change of an output of the photodiode, a distance of an object (a user face, etc., for example) that is in close to the proximity sensor 34 (mobile phone 10). Specifically, the light emitting element emits an infrared ray, and the light receiving element receives an infrared ray that is reflected by the face etc. For example, when the light receiving element is far from a user face, an infrared ray that is emitted from the light emitting element is hardly received by the light receiving element. On the other hand, when a user face approaches the proximity sensor 34, an infrared ray that is emitted by the light emitting element is reflected on the face to be received by the light receiving element. Since a light receiving amount by the light receiving element thus changes in a case where the proximity sensor 34 is in close to the user face or a case where that is not so, the processor 40 can calculate the distance from the proximity sensor 34 to an object based on the light receiving amount.

The infrared LED 30 shown in FIG. 1 is connected to an LED driver 60. The LED driver 60 switches ON/OFF (lighting/extinction) of the infrared LED 30 based on a control signal from the processor 40.

An infrared camera 32 (see FIG. 1) that functions as an imaging module is connected to the imaged image processing circuit 62. The imaged image processing circuit 62 performs image processing on imaged image data from the infrared camera 32, and inputs monochrome image data into the processor 40. The infrared camera 32 performs imaging processing under instructions of the processor 40, and inputs the imaged image data into the imaged image processing circuit 62. The infrared camera 30 is constituted by a color camera using an imaging device such as a CCD or CMOS and an infrared filter that reduces (cuts-off) lights of wavelengths of R, G and B and passes a light of wavelength of infrared ray, for example. Therefore, if structure that the infrared filter can be freely attached or detached is adopted, by removing the infrared filter, it is possible to obtain a color image.

In addition, the above-mentioned wireless communication circuit 42, A/D converter 44 and D/A converter 46 may be included in the processor 40.

In the mobile telephone 10 having such structure, instead of a key operation or a touch operation, it is possible to perform an input operation by an eye-gaze (hereinafter, may be called “eye-gaze operation”). In the eye-gaze operation, predetermined processing that is set corresponding to a predetermined area (hereinafter, decision area) designated by a point (point of gaze) that an eye-gaze and the display surface of the display 14 intersect is performed. In the following, a detection method of a point of gaze will be described using drawings.

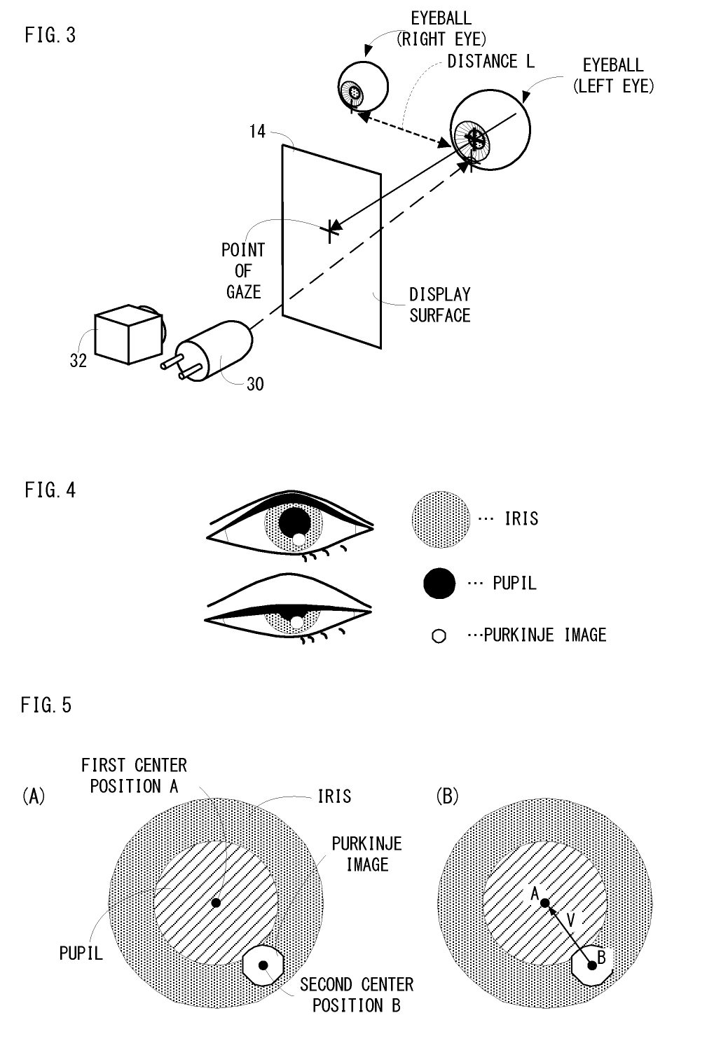

With reference to FIG. 3, a user sets own dominant eye among eyes on either side. If setting the dominant eye (here, left eye), a face of the user (imaging subject) irradiated with the infrared ray emitted by the infrared LED 30 is imaged by the infrared camera 32. An eyeball circumference image is acquired using technology of characteristic point extraction to the imaged image. Next, a pupil is detected by labeling processing to the eyeball circumference image that is acquired, and a reflection light (Purkinje image) by the infrared ray (infrared light) is detected by differential filter Processing. In addition, although methods of detecting the pupil and the Purkinje image from the imaged image is outlined, since these methods are already well-known and it is not the essential content of this embodiment, a detailed description thereof is omitted.

Since the infrared LED 30 and the infrared camera 32 are arranged (closely arranged) below the display 14 side by side as shown in FIG. 1, the Purkinje image can be is detected even either state that an eyelid is relatively largely opened or a state an eyelid is slightly closed, as shown in FIG. 4. In addition, the distance between the infrared LED 30 and the infrared camera 32 is determined by a distance between the user face and the mobile phone 10 (surface of the housing or display surface of the display 14) at the time that the user uses the mobile phone 10, a size of the mobile phone 10, etc,

If detecting a pupil and a Purkinje image from the imaged image, the processor 40 detects a direction of the eye-gaze of the dominant eye (eye vector V). Specifically, a vector toward a position of the pupil from a position of the Purkinje image in a two-dimensional imaged image that is imaged by the infrared camera 32 is detected. That is, as shown in FIGS. 5(A) and 5(B), a vector turned from the first center position A to the second center position B is the eye vector V. A coordinate system in the infrared camera 32 is determined in advance, and the eye vector V is calculated using the coordinate system.

Then, a calibration is performed as initial setting of an eye-gaze operation using the eye vector V thus calculated. In this embodiment, an eye vector V at the time that each of four (4) corners of the display 14 is gazed is acquired, and save respective eye vectors V as calibration data.

In performing an eye-gaze operation, a point of gaze is detected by evaluating an eye vector V at every time that an image is imaged by the infrared camera 32 and comparing it with the calibration data. Then, when the number of times that the point of gaze is detected within the decision area corresponds to the number of decision times associated with the decision area, the processor 40 detects that an eye-gaze input is made to that point of gaze.

Furthermore, in this embodiment, a distance between both eyes of the user (see FIG. 3) is calculated based on center positions of Purkinje images of the both eyes. Then, the distance L of both eyes of the user is saved together with the calibration data. If the eye vector V is calculated by performing that processing that detects a point of gaze, the distance L of both eyes recorded at the time that the point of gaze is detected is compared with a distance L of both eyes at present to determine whether the distance between the display 14 and the user face changes. If determining that the distance between the display 14 and the face of the user changes, a change amount is calculated based on the distance L of both eyes being recorded and the distance L of both eyes at present, whereby a magnitude of the eye vector is corrected. If it is determined based on the change amount that it is in a state where a position of the user face is departed in comparison with the position at the time of performing the calibration, the eye vector V is corrected so as to become large. If it is determined based on the change amount that it is in a state where a position of the user face is closed in comparison with the position at the time of performing the calibration, the eye vector V is corrected so as to become small.

Furthermore, although a detailed description is omitted, in point-of-gaze detection processing of this embodiment, an error that occurs with a shape of an eyeball, a measurement error at the time of the calibration, a quantization error at the time of imaging, etc. are also corrected.

Therefore, in this embodiment, even if it is a small electronic apparatus such as the mobile phone 10, it becomes possible to implement a highly precise eye-gaze input.

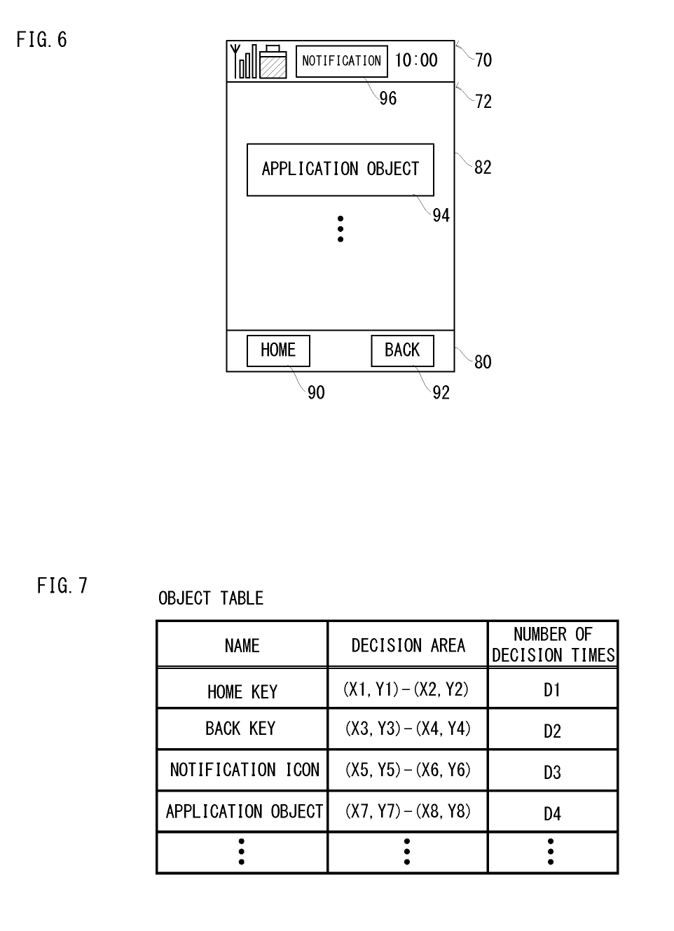

FIG. 6 is an illustration view showing a general example of the display of the display 14 when an application is being performed. The display 14 includes a status displaying area 70 and a function displaying area 72. In the status displaying area 70, an icon (picto) indicative of a radio-wave reception state by the antenna 44, an icon indicative of a residual battery capacity of a secondary battery and the time are displayed.

In the function display area 72, a key display area 80 displaying a HOME key 90 and a BACK key 92 that are standard keys, and an application display area 82 displaying an application object 94 etc, are included. The HOME key 90 is a key for terminating the application being performed and displaying a standby screen. The BACK key 92 is a key for terminating the application being performed and displaying a screen before performing application. Then, regardless of a kind of application to be performed, the HOME key 90 and the BACK key 92 are displayed whenever the application is performed. The application object 94 collectively shows objects displayed according to the application to be performed. Therefore, when the application is being performed, the application object 94 is displayed as a GUI such as a key.

Furthermore, when there is an unread new-arrival mail, missed call or the like, a notification icon 96 is displayed in the status display area 70. For example, when a new-arrival mail is received, a new-arrival mail icon 96a is displayed in the status display area 70 as the notification icon 96. Furthermore, when there is no unread new-arrival mail or missed call, the notification icon 96 is not displayed.

Then, the user can arbitrarily operate the application being performed by performing an eye-gaze input to these objects. For example, if an eye-gaze input is performed to the notification icon 96, an application displaying the notification icon 96 is performed.

In addition, an icon, a key, a GUI, a widget (gadget), etc. are included in the object of this embodiment.

FIG. 7 is an illustration view showing an example of a format of an object table. In the object table, columns that a name, a decision area and the number of decision times of the object being displayed on the display 14 are respectively recorded are included. Here, the decision area of this embodiment is not only an area that receives an eye-gaze input but also a display area that displays an image of an object.

The HOME key, the BACK key, the notification icon, the application object, etc. are recorded in the column that the name of the object is to be recorded. Corresponding to the column of the name, a coordinate range that each object receives an eye-gaze input is recorded in the column that the decision area of the object is to be recorded. Corresponding to the column of the name, the number of decision times of each object is recorded in the column that the number of decision times of the object is to be recorded.

In the object table, corresponding to the HOME key 90, for example, in the decision area of “(X1, Y1)-(X2, Y2)” is recorded, and the number of decision times of “D1” is recorded. Similarly, corresponding to the BACK key 92, the decision area of “(X3, Y3)-(X4, Y4)” is recorded, and the number of decision times of “D2” is recorded, Corresponding to the notification icon 96, the decision area of “(X5, Y5)-(X6, Y6)” is recorded, and the number of decision times of “D3” is recorded. Then, corresponding to the application object, the decision area of “(X7, Y7)-(X8, Y8)” is recorded, and the number of decision times of “D4” is recorded. It should be noted that the name, the decision area and the number of decision times of the application object are changed corresponding to an application to be performed.

In addition, in this embodiment, the same standard value (10, for example) is set to the number of decision times for each object. However, in other embodiments, different values may be set for each object.

Here, in this embodiment, if an event such as reception of a new-arrival mail, change of a display screen or the like occurs, a next user operation is forecasted, and responsivity of an eye-gaze input to the object for performing the next user operation is improved.

In this embodiment, in order to improve the responsivity of an eye-gaze input, a decision area is expanded see FIG. 13(B)) and the number of decision times is made smaller than the standard value. That is, since a range that receives an eye-gaze input by the user becomes large if the decision area is expanded, an eye-gaze input becomes easy to be received. Furthermore, by making the number of decision times of the object small, time until it is decided as an eye-gaze input can be shortened. However, in other embodiments, an eye-gaze may be guided by changing a display manner a size, a color, etc., for example) of the object. That is, operability of an eye-gaze input is improved by guiding an eye-gaze of the user.

Since the responsivity of an eye-gaze input to the object is thus improved for a next user operation, the operability of an eye-gaze input is improved. Furthermore, since the operating time of an eye-gaze input will be shortened if the operability of an eye-gaze input is improved, the mobile phone 10 can detect an eye-gaze input with low power consumption.

In addition, in order to improve the responsivity of an eye-gaze input, only an decision area may be expanded, or only the number of decision times may be made small, or only the display manner may be changed. Furthermore, two of these processing may be combined arbitrarily.

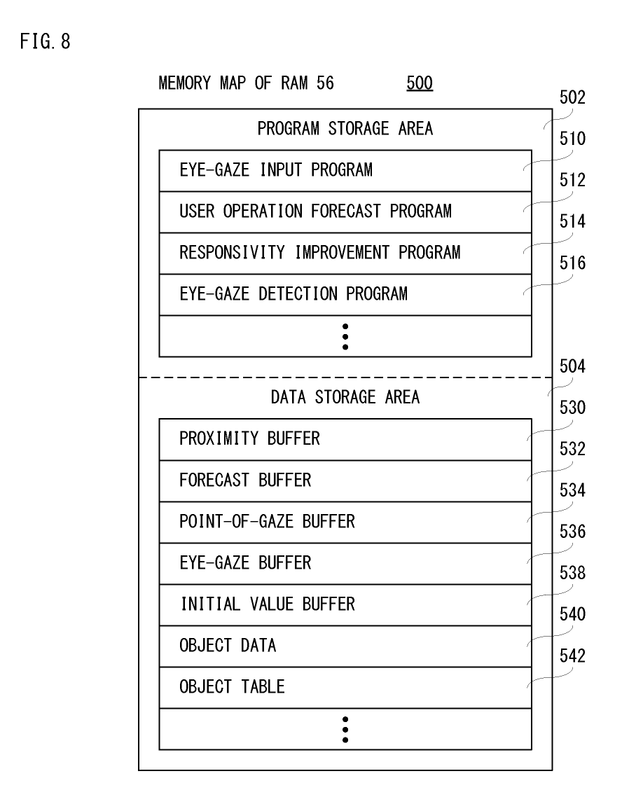

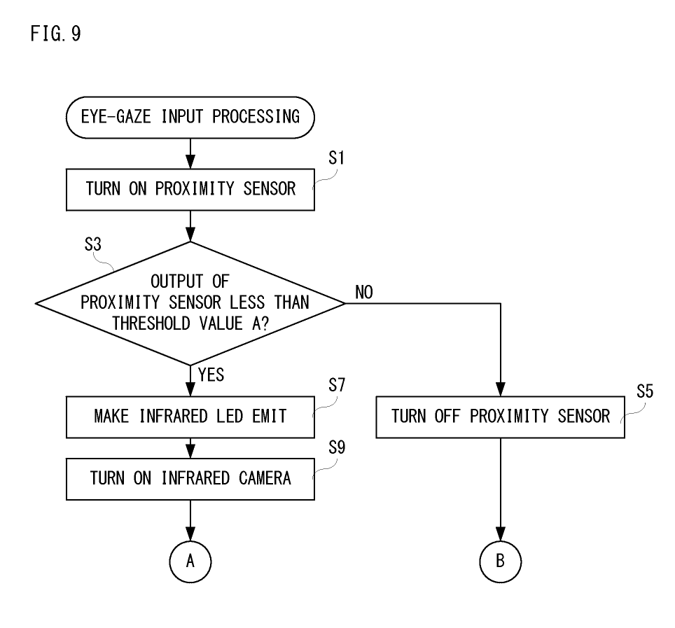

In the following, the outline of this embodiment will be described using a memory map 500 shown in FIG. 8 and flowcharts shown in FIG. 9-FIG. 11.

With reference to FIG. 8, a program storage area 502 and a data storage area 504 are formed in the RAM 56 shown in FIG. 2. As described previously, the program storage area 502 is an area for reading and storing (developing) a whole or a part of program data that is set in advance in the flash memory 54 (FIG. 2).

The program storage area 502 is stored with an eye-gaze input program 510 for performing an operation based on an eye-gaze input, a user operation forecast program 512 for forecasting a next user operation when an event occurs, a responsivity improvement program 514 for improving the responsivity of an eye-gaze input, an eye-gaze detection program 516 for detecting an input position of an eye-gaze input, etc. In addition, the eye-gaze detection program 516 is a subroutine of the eye-gaze input program 510. Furthermore, in the program storage area 502, programs for performing a telephone function, a mail function, an alarm function, etc. are also included.

The data storage area 504 is provided with a proximity buffer 530, a forecast buffer 532, a point-of-gaze buffer 534, an eye-gaze buffer 536, an initial value buffer 538, etc., and stored with object data 540 and a object table 542.

The proximity buffer 530 is temporarily stored with distance information to the object obtained from the proximity sensor 34. The forecast buffer 532 is temporarily stored with a name of an object for performing a next user operation that is forecasted at the time that an event occurs. The point-of-gaze buffer 534 is temporarily stored with a point of gaze that is detected. When an eye-gaze input is detected, the eye-gaze buffer 536 is temporarily stored with its position. When a decision area is expanded, the initial value buffer 538 is temporarily stored with a coordinate range indicating an original size.

The object data 540 is data comprising an image, character string data, etc. of an object to be displayed on the display 14. The object table 542 is a table having a format shown in FIG. 7, for example.

Although illustration is omitted, the data storage area 504 is further stored with other data necessary for performing respective programs stored in the program storage area 502, and provided with counters and flags.

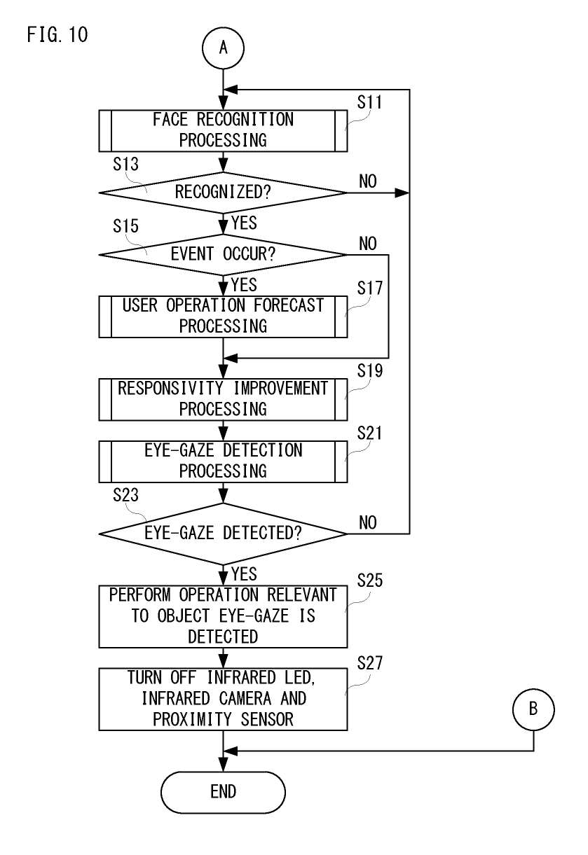

The processor 40 processes a plurality of tasks including eye-gaze input processing shown in FIG. 9 and FIG. 10, etc., in parallel to each other under control by Linux (registered trademark)-basis OS such as Android (registered trademark), REX, etc. or other OS.

If an operation by an eye-gaze input is validated, eye-gaze input processing is performed. The processor 40 turns on the proximity sensor 34 in a step S1. That is, a distance from the mobile phone 10 a user is measured by the proximity sensor 34. Subsequently, the processor 40 determines whether an output of the proximity sensor 34 is less than a threshold value A in a step S3. That is, it is determined whether a user face exists within a range that an infrared ray emitted from the infrared LED 30 affects a user eye. If “NO” is determined in the step S3, that is, if the output of the proximity sensor 34 is equal to or more than the threshold value A, the processor 40 turns off the proximity sensor 34 in a step S5, and terminates the eye-gaze input processing. That is, since the infrared ray that is output from the infrared LED 30 may affect the user eye, the eye-gaze input processing is terminated. In addition, in other embodiments, notification (pop-up or a voice, for example) that urges to depart the user face from the mobile phone 10 may be performed after the step S5.

If “YES” is determined in the step S3, that is, if the mobile phone 10 and the user face are in an appropriate distance, for example, the processor 40 turns on the infrared LED 30 in a step 57, and turns on the infrared camera 32 in a step 39. That is, in order to detect an eye-gaze input of the user, the infrared LED 30 and the infrared camera 32 are turned on.

Subsequently, the processor 40 performs face recognition processing in a step S11. That is, the processing that detects the user face from an image of the user that is imaged by the infrared camera 32 is performed. Subsequently, the processor 40 determines whether the face is recognized in a step S13. That is, it is determined whether the user face is recognized by the face recognition processing. If “NO” is determined in the step S13, that is, if the user face is not recognized, the processor 40 returns to the processing of the step S11.

On the other hand, if “YES” is determined in the step S13, that is, if the user face is recognized, the processor 40 determines, in a step S15, whether an event occurs. For example, the processor 40 determines whether a new-arrival mail is received or a screen is changed. If “NO” is determined in the step S15, that is, if such an event does not occur, the processor 40 proceeds to processing of a step S19.

Further ore, if “YES” is determined in the step S15, that is, if an event occurs, the processor 40 performs user operation forecast processing in a step S17, and performs responsivity improvement processing in the step S19. That is, in response to occurrence of an event, the processor 40 forecasts a next user operation and improves responsivity of the object for performing the next user operation. In addition, since the user operation forecast processing and the responsivity improvement processing will be described later using the drawings and flowcharts, a detailed description is omitted here. Furthermore, the processor 40 performing the processing of the step 317 functions as a forecast module, and the processor 40 performing the processing of the step S19 functions as an improvement module.

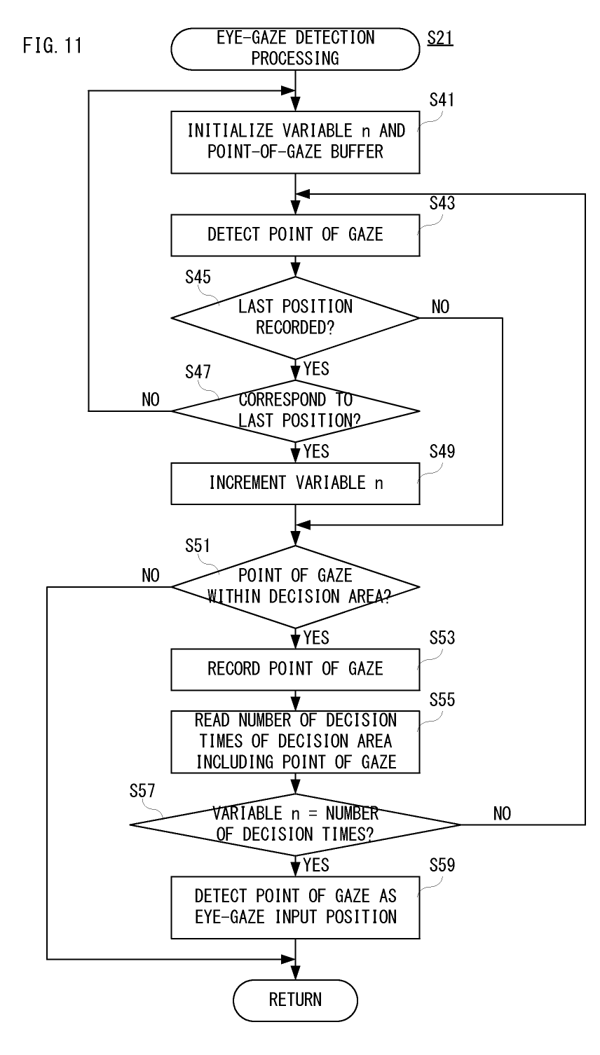

Subsequently, the processor 40 performs eye-gaze detection processing in a step S21. That is, an eye-gaze input of the user is detected. in addition, since the eye-gaze detection processing will be described later using a flowchart showing in FIG. 11, a detailed description is omitted here.

Subsequently, the processor 40 determines, in a step S23, whether an eye-gaze is detected. That is, the processor 40 determines whether an input position of the eye-gaze input by the user can be detected. if “NO” is determined in the step S23, that is, if the eye-gaze of the user is not turned to the object, for example, the processor 40 returns to the processing of the step S11.

Furthermore, if “YES” is determined in the step S23, that is, if the eye-gaze of the user is turned to an arbitrary object, for example, the processor 40 performs, in a step S25, an operation relevant to the object that the eye-gaze input is detected. When an eye-gaze input is performed to the HOME key 90, for example, the processor 40 terminates the application being performed and displays a standby screen on the display 14.

Subsequently, the processor 40 turns off the infrared LED 30, the infrared camera 32 and the proximity sensor 34 in a step S27. That is, since the eye-gaze input is detected, by turning off the power applied to such the components, power consumption of the mobile phone 10 can be suppressed.

FIG. 11 is a flowchart of the eye-gaze detection processing. When the processing of the step S21 of the eye-gaze input processing shown in FIG. 10 is performed, the eye-gaze detection processing becomes to be performed. The processor 40 initializes a variable n and the point-of-gaze buffer 534 in a step S41. That is, the variable n for counting the number of times that a point of gaze is detected in the same position and the point-of-gaze buffer 534 that is recorded temporarily with a point of gaze that is detected are initialized.

Subsequently, the processor 40 detects a point of gaze in a step S43. That is, a position that the user is gazing at the display 14 is calculated from the image that the face is recognized. In addition, the processor 40 performing the processing of the step S43 functions as a first detection module.

Subsequently, the processor 40 determines, in a step S45, whether a last position is recorded. That is, the processor 40 determines whether a point of gaze that is detected by the last processing is recorded in the point-of-gaze buffer 534. If “NO” is determined in the step S45, that is, if the last point of gaze is not recorded, the processor 40 proceeds to processing of a step S51. On the other hand, if “YES” is determined in the step S45, that is, if the last point of gaze is recorded in the point-of-gaze buffer 534, the processor 40 determines, in a step S47, whether the point of gaze corresponds to the last point of gaze. That is, the processor 40 determines whether the point of gaze detected in the step S43 corresponds the last point of gaze recorded in the point-of-gaze buffer 534.

If “NO” is determined in the step S47, that is, if the point of gaze that is detected does not corresponds to the last point, the processor 40 returns to the processing of the step S41. If “YES” is determined in the step S47, that is, if the point of gaze that is detected corresponds to the last point, the processor 40 increments the variable n in a step S49. That is, the number of times that the points of gaze correspond to each other is counted by the variable n. In addition, the processor 40 performing the processing of the step S49 functions as a count module.

Subsequently, the processor 40 determines, in a step S51, whether the point of gaze is within the decision area. That is, the processor 40 determines whether the point of gaze detected is included in any one of respective decision areas recorded in the object table 542. If “NO” is determined in the step 551, that is, if the point of gaze is not included in the decision area, the processor 40 terminates the eye-gaze detection processing, and returns to the eye-gaze input processing.

On the other hand, if “YES” is determined in the step S51, that is, if the point of gaze detected is included in the application object, for example, the processor 40 records the point of gaze in a step S53. That is, the point of gaze detected is recorded in the point-of-gaze buffer 534 as a last detected point. Subsequently, the processor 40 reads the number of decision times of the decision area that includes the point of gaze in a step S55. When the point of gaze detected is included in the decision area of the application object, for example, “D4” is read as the number of decision times.

Subsequently, the processor 40 determines, in a step S57, whether the variable n corresponds to the number of decision times. That is, the processor 40 determines whether the number of times that the point of gaze is detected in the same position reaches the number of decision times of the decision area including that point of gaze. If “NO” is determined in the step S57, that is, if the number of times counted by the variable n, for example is less than the number of decision times, the processor 40 returns to the processing of the step S43.

If “YES” is determined in the step S57, that is, if a value that is counted by the variable n, for example corresponds to the number of decision times D4 that is read, the processor 40 detects the point of gaze as a position of the eye-gaze input in a step S59. That is, the processor 40 records the coordinate recorded in the point-of-gaze buffer 534 in the eye-gaze buffer 536 as an input position. Then, after the processing of the step S59 is ended, the processor 40 terminates the eye-gaze detection processing, and returns to the eye-gaze input processing. In addition, the processor 40 performing the processing of the step S59 functions as a second detection module.

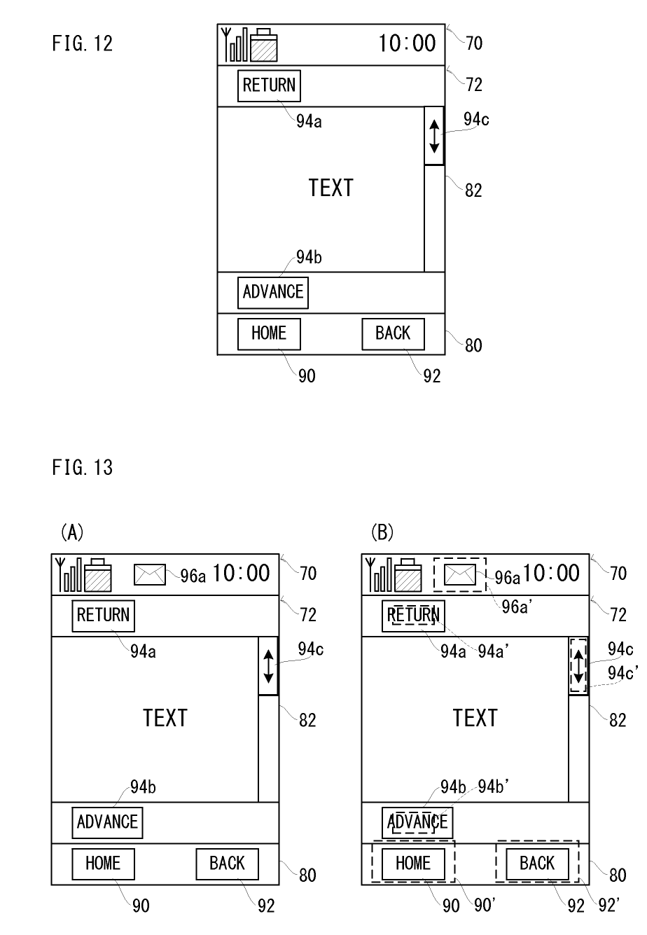

Although the outline of this embodiment is described above, in the following, specific examples will be described using illustration views and flowcharts showing in FIG. 12-FIG. 24.

### Specific Example 1

In the specific example 1, improvement of the responsivity of the eye-gaze input when a notification event by the application occurs is described.

FIG. 12 shows a display example of the display 14 when a digital book application is being performed. While a text of the digital book reproduced by the digital book application is displayed, an application object 96 of the digital book application is displayed on the application display portion 82. A return key 94a for returning to a previous page, an advance key 94b for advancing to a next page and a scroll bar 94c for scrolling the display content are included in the application object 96 of the digital book application.

If a mail application receives a new-arrival mail when respective objects are thus being displayed on the display 14, as shown in FIG. 13(A), a new-arrival mail icon 96a becomes to be displayed in the status display area 70. Then, if an event that notifies the reception of a new-arrival mail occurs, the decision area of the object for performing the mail application is expanded, and the number of decision times is made small.

With reference to FIG. 13(B), if a reception event of the new-arrival mail occurs, a decision area 96a′ of the new-arrival mail icon 96a and the decision area 90′ and the decision area 92′ of the HOME key 90 and the BACK key 92 for terminating the application being performed are expanded. On the other hand, decision areas of objects not related to performance of the email application, here, the return key 94a, the advance key 94b and the scroll bar 94c are reduced. Furthermore, although not illustratable in FIG. 13(B), the numbers of decision times of the new-arrival mail icon 96a, the HOME key 90 and the BKCK key 92 are made small.

Here, the responsivity of the new-arrival mail icon 96a for the eye-gaze input is improved as the object for performing the email application. Furthermore, since the HOME key 90 and the BACK key 92 are the objects for terminating the application being performed, in order to perform the email application, the responsivity of the eye-gaze input is improved for each of them.

Thus, if an event that displays the notification icon 96 occurs, it is possible to make the content being notified easy to confirm.

In addition, although each decision area is shown by a dotted line in FIG. 13(B), this is only for illustrating expansion/reduction of the decision area intelligibly, and therefore, the user cannot in fact recognize expansion/reduction of the decision area.

In other embodiments, when an incoming call of a telephone or a time by an alarm is notified, notification icon 96 corresponding to the application may be displayed on the display 14.

In the following, the user operation forecast processing and the responsivity improvement processing of the specific example 1 will be described in detail using flowcharts.

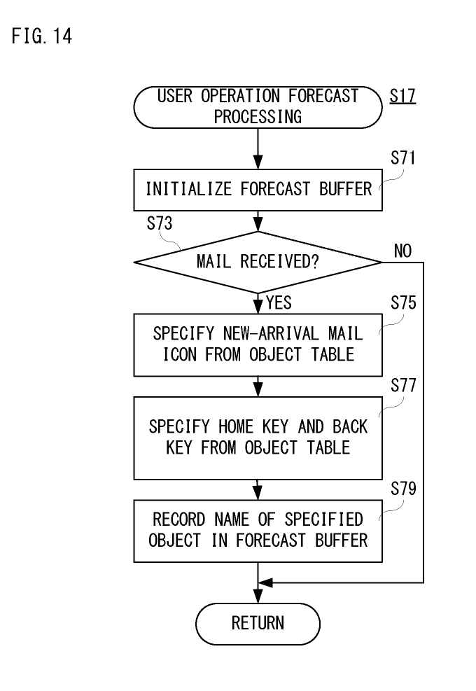

FIG. 14 is a detailed flowchart of the user operation forecast processing of the specific example 1, If the user operation forecast processing is performed in the step S17 of the eye-gaze input processing, the processor 40 initializes the forecast buffer 532 in a step S71. That is, in order to record a name of an object for performing a next user operation, information stored in the forecast buffer 532 is eliminated.

Subsequently, the processor 40 determines, in a step 373, whether a mail is received. That is, it is determined whether an event that notifies the reception of a new-arrival mail occurs. If “NO” is determined in the step S73, that is, if a notification event does not occur, the processor 40 terminates the user operation forecast processing, and returns to the eye-gaze input processing.

If “YES” is determined in the step S73, that is, if the event occurred is the reception of a new-arrival mail, the processor 40 specifies the new-arrival mail icon 96a from the object table 542 in a step S75. That is, the new-arrival mail icon 96a is specified as an object for performing the mail application. In addition, the processor 40 performing the processing of the step S75 functions as a first forecast module.

Subsequently, the processor 40 specifies the HOME key 90 and the BACK key 92 from the object table 542 in a step 377. That is, the HOME key 90 and the BACK key 92 are specified as the objects for terminating the application being performed.

Subsequently, the processor 40 records the name of the object specified in the forecast buffer 532 in a step S79. That is, the names of the objects of the new-arrival mail icon 96a, the HOME key 90 and the BACK key 92 are recorded in the forecast buffer 532. Then, after the processing of the step S79 is ended, the processor 40 terminates the user operation forecast processing, and returns to the eye-gaze input processing.

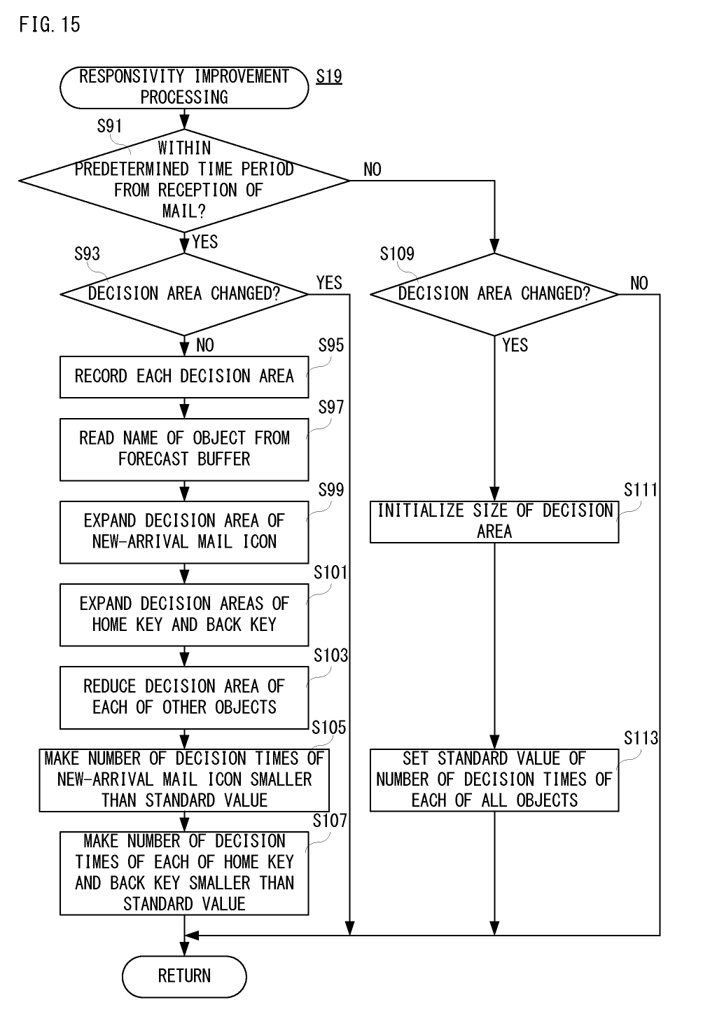

FIG. 15 is a detailed flowchart of the responsivity improvement processing of the specific example 1. If the responsivity improvement processing is performed in the step S19 of the eye-gaze input processing, the processor 40 determines, in a step S91, whether a time period from the reception of the mail is within a predetermined time period (5 minutes, for example). That is, the processor 40 determines whether the predetermined time period elapses after receiving a new-arrival mail.

If “YES” is determined in the step S91, that is, if the predetermined time period does not elapse after receiving the new-arrival mail, the processor 40 determines, in a step S93, whether the decision area has been changed. That is, the processor 40 determines whether it is in a state where the responsivity of each of the new-arrival mail icon 96a, the HOME key 90 and the BACK key 92 has been improved. Specifically, the processor 40 determines whether information on the coordinate range indicative of an original size of each decision area is recorded in the initial value buffer 538. If “YES” is determined in the step S93, that is, if the decision area has been changed, the processor 40 terminates the responsivity improvement processing, and returns to the eye-gaze input processing.

If “NO” is determined in the step S93, that is, if the decision area has not been expanded yet, the processor 40 records a size of each decision area in a step S95. That is, the information indicative of the coordinate range of each decision area is recorded in the initial value buffer 538. Subsequently, the name of the object is read from the forecast buffer 532 in a step S97. That is, the name of the object that is forecasted by the user operation forecast processing is read. In addition, in the specific example 1, the names of the objects of the new-arrival mail icon 96a, the HOME key 90 and the BACK key 92 are read.

Subsequently, the processor 40 expands the decision area of the new-arrival mail icon 96a in a step S99, and expands the decision areas of the HOME key 90 and the BACK key 92 in a step S101. Subsequently, the processor 40 reduces the decision areas of other objects in a step S103. For example, the decision areas of the return key 94a, the advance key 94b and the scroll bar 94c are reduced. Therefore, as shown in FIG. 13(B), it is in a state where the sizes of the decision areas are changed by the processing. In addition, a result that each of the decision areas is expanded/reduced is reflected in each section of the decision area of the object table.

Subsequently, the processor 40 makes the number of decision times of the new-arrival mail icon 96a smaller than a standard value in a step S105, and makes the number of decision times of each of the HOME key 90 and the BACK key 92 smaller than a standard value in a step S107. That is, in the object table 542, the number of decision times corresponding to each of these objects is made smaller than the standard value.

Then, if the responsivity of each object is thus changed, the processor 40 terminates the responsivity improvement processing and return to the eye-gaze input processing.

In addition, the processor 40 performing the processing of the step S99 and step S105 functions as a first improvement module.

Here, if “NO” is determined in the step S91, that is, if the predetermined time period elapses after the reception of the new-arrival mail, the processor 40 determine, in a step S109, whether the decision area has been changed. That is, it is determined whether the responsivity of each object has been changed. If “NO” is determined in the step S109, that is, if the responsivity of each object has not been changed yet, the processor 40 terminates the responsivity improvement processing, and returns to the eye-gaze input processing.

On the other hand, if “YES” is determined in the step S109, that is, the responsivity of each of the new-arrival mail con 96a, the HOME key 90 and the BACK key 92 is improved, for example, the processor 40 initializes the size of the decision area in a step S111. That is, the processor 40 returns the coordinate range of each decision area recorded in the object table 542 to the original state based on the coordinate range indicative of the decision area of each object recorded in the initial value buffer 538.

Subsequently, the processor 40 sets the standard value to the number of decision times of each of all the objects in a step S113. That is, the standard value is set in each section in the column of the number of decision times of the object table 542. However, in other embodiments, the number of decision times that is initialized may differ according to the object. If the responsivity changed is thus returned, the processor 40 terminates the responsivity improvement processing, and returns to the eye-gaze input processing.

### Specific Example 2

In the specific example 2, improvement of the responsivity of an eye-gaze input when an event that the application being performed is rendered in a specific state occurs. In addition, in the specific example 2, like the specific example 1, an example that the digital book application is being performed will be described.

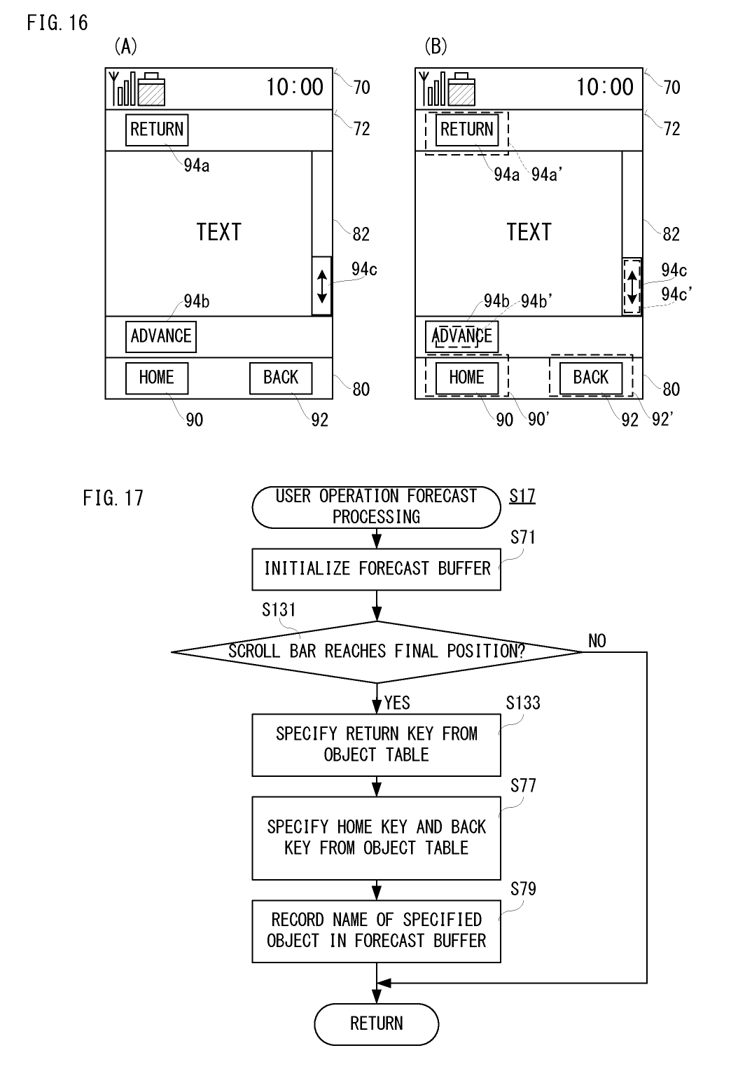

With reference to FIG. 16(A), if a page being displayed is scrolled to the last, that is, if a position of the scroll bar 94c reaches the last position when the digital book application is being performed, it is determined that an event that it is rendered in a state where a possibility that the application being performed is terminated is high (specific state) occurs.

With referring to FIG. 16(B), if such an event occurs, the decision area 90′ and the decision area 92′ of the HOME key 90 and the BACK key 92 for terminating the application being performed and the decision area 94a′ of the return key 94a are expanded. Furthermore, the decision areas of other objects having nothing to do with termination of the application, that is, the advance key 94b and the scroll bar 94c are reduced. Furthermore, in a state of FIG. 16(B), the number of decision times of each of the HOME key 90, the BACK key 92 and the return key 94a is made smaller than the standard value.

Here, the responsivity of the eye-gaze input for the HOME key 90 and the BACK key 92 are improved as an object for terminating the application being performed. In addition, since the user may confirm a previous page, the responsivity of the return key 94a of an eye-gaze input is improved.

Thus, in the specific example 2, if the display content is scrolled to the last, it becomes easy to terminate the application being performed.

In addition, the specific example 2 may be applied not only to the digital book application but also to the application that the display content is scrolled such as mail application, browser application, text creation/edit application, etc.

In the following, the user operation forecast processing and the responsivity improvement processing of the specific example 2 will be described in detail using flowcharts. In addition, about the same processing as the specific example 1, by applying the same step numbers, a detailed description will be omitted.

FIG. 17 is a detailed flowchart of the responsivity improvement processing of the specific example 2. If the user operation forecast processing is performed in the step S17 of the eye-gaze input processing, the processor 40 initializes the forecast buffer 532 in a step S71.

Subsequently, the processor 40 determine, in a step S131, whether the scroll bar 94c reaches the last position. That is, the processor 40 determines whether an event that the application being performed is rendered in a specific state occurs. If “NO” is determined in the step S131, that is, if the scroll bar 94c does not reach the last position, the processor 40 terminates the user operation forecast processing, and returns to the eye-gaze input processing.

If “YES” is determined in the step S131, that is, if the scroll bar 94c reaches the last position, the processor 40 specifies the return key 94a from the object table 542 in a step S133. That is, since the user may perform an operation to return to the previous page, the return key 94a is specified from the object table.

Subsequently, the processor 40 specifies the HOME key 90 and the BACK key 92 from the object table 542 in the step S77. That is, the HOME key 90 and the BACK key 92 are specified as objects for terminating the application being performed. In addition, the processor 40 performing the processing of the step S77 functions as a second forecast module.

Subsequently, the processor 40 records the name of the object specified in the forecast buffer 532 in the step S79. Here, the names of the object of the HOME key 90, the BACK key 92 and the return key 94a are recorded in the forecast buffer 532. Then, after the processing of the step S79 is ended, the processor 40 terminates the user operation forecast processing, and returns to the eye-gaze input processing.

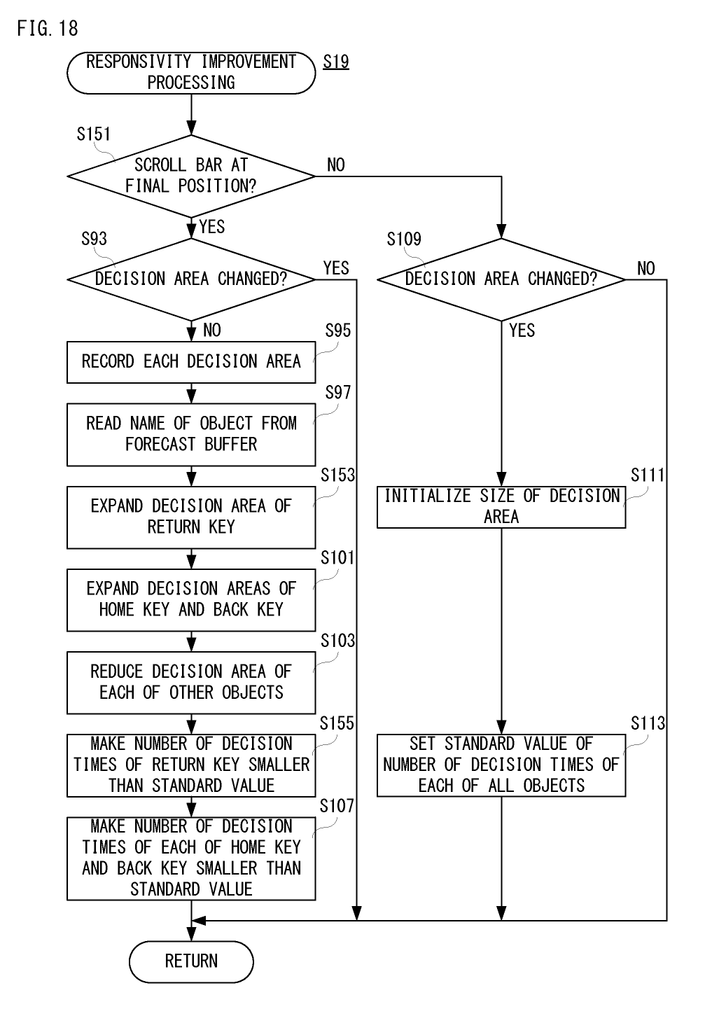

FIG. 18 is a detailed flowchart of the responsivity improvement processing of the specific example 2. If the responsivity improvement processing is performed in the step S19 of the eye-gaze input processing, the processor 40 determines, in a step S151, whether the scroll bar 94 is at the last position. That is, it is determined whether the display content is scrolled to the last.

If “YES” is determined in the step S151, that is, if the display content is scrolled to the last, the processor 40 determines, in the step S93, whether the decision area has been changed. If “YES” is determined in the step S93, that is, if the decision area has been changed, the processor 40 terminates the responsivity improvement processing, and returns to the eye-gaze input processing. If “NO” is determined in the step S93, that is, if the decision area has not been expanded yet, the processor 40 records a size of each decision area in the step S95.

Subsequently, the processor 40 reads the name of the object from the forecast buffer 532 in the step S97. Here, the HOME key 90, the BACK key 92 and the return key 94a are read as the names of the objects.

Subsequently, the processor 40 expands the decision area of the return key 94a in a step S153, and expands the decision areas of the HOME key 90 and the BACK key 92 in the step S101. Subsequently, the processor 40 reduces the decision areas of other objects in the step S103. For example, the decision areas of the advance key 94b and the scroll bar 94c are reduced. in addition, a result that the decision areas are expanded/reduced is reflected in each section of the decision area of the object table.

Subsequently, the processor 40 makes the number of decision times of the return key 94a smaller than a standard value in a step S155, and makes the number of decision times of each of the HOME key 90 and the BACK key 92 smaller than a standard value in the step S107. That is, the number of decision times of each of the HOME key 90, the BACK key 92 and the return key 94a in the object table 542 is made small. If the responsivity of each of the HOME key 90, the BACK key 92 and the return key 94a is thus improved, the processor 40 terminates the responsivity improvement processing, and returns to the eye-gaze input processing.

In addition, the processor 40 performing the processing of the step S101 and the step S107 functions as a second improvement module.

Furthermore, if “NO” is determined in the step S151, that is, if the scroll bar becomes not at the last position, the processor 40 determines, in a step S109, whether the decision area has been changed. If “NO” is determined in the step S109, that is, the decision area has not been changed, the processor 40 terminates the responsivity improvement processing, and returns to the eye-gaze input processing.

If “YES” is determined in the step S109, that is, if the decision area has been changed, the processor 40 initializes the size of the decision area in the step S111, and sets the standard value to the number of decision times of each of all the objects in the step S113. That is, the responsivity of each object is returned to the original state. Then, if the processing of the step S113 is ended, the processor 40 terminates the responsivity improvement processing, and returns to the eye-gaze input processing.

### Specific Example 3

In the specific example 3, improvement of the responsivity of an eye-gaze input when an event that displays a specific screen including performance icons that a plurality of applications can be performed, respectively occurs.

FIG. 19(A) shows a display example of the display 14 when a lock screen is being displayed. The lock screen is displayed in the function display area 72. Furthermore, the lock screen includes a lock icon RI for canceling a lock state and performance icons 110-116 for performing a plurality of applications. The performance icons of the specific example 3 include a mail icon 110 for performing a mail application, a browser icon 112 for performing a browser application, a map icon 114 for performing a map application and a telephone icon 116 for performing a telephone application.

For example, the lock screen is a screen for preventing an erroneous input to the touch panel 16, and displayed when the power supply of the display 14 is turned on. If the user performs a cancellation operation (for example, a flick operation to take out the lock icon RI outside a screen) when the lock screen is being displayed, the user can cancel the lock state. Furthermore, if dropping the lock icon RI on an arbitrary performance icon after dragging it, the user can perform an application corresponding to that performance icon while canceling the lock state. Then, when the lock screen is canceled, a standby screen is displayed.

Furthermore, even if the user performs an eye-gaze input to the lock icon RI, the lock state can be canceled. If the user performs an eye-gaze input to an arbitrary performance icon, the user can perform an application corresponding to that performance icon while canceling the lock state.

Here, in the specific example 3, if a display event of the lock screen as shown in FIG. 19(A) occurs, the responsivity of the performance object corresponding to an application that a frequency used by the user is high is improved.

With reference to FIG. 19(B), if a display event of a lock screen occurs at the time that an application that a use frequency of the user is the largest is a mail application, for example, a decision area 110′ of the mail icon 110 corresponding to the mail application with the highest use frequency and a decision area RI′ of the lock icon RI for canceling the lock state are expanded. In a state of FIG. 19(B), the number of decision times of each of the mail icon 110 and the lock icon RI is made smaller than a standard value.

That is, as to a performance icon corresponding to an application with a high use frequency, in order to make the application easy to perform, the responsivity of an eye-gaze input is improved. In addition, in order to make a lock state easy to cancel, the responsivity of the lock icon RI of an eye-gaze input is improved.

Therefore, if the screen that an application can he performed is displayed, based on a use history, it is possible to render in a state being easy to perform the application.

In addition, in FIG. 19(B), if the size of the decision area and the size of the object correspond to each other, a reference numeral for the decision area is omitted.

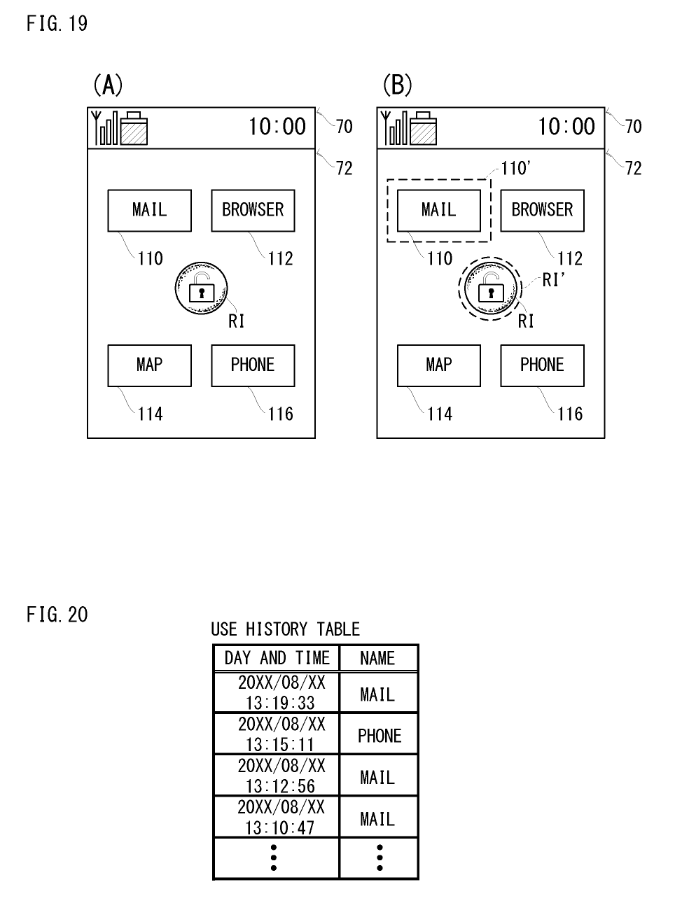

FIG. 20 is an illustration view showing an example of a format of a use history table that a history of an application used by the user is recorded. The use history table includes columns for recording the date and time that the application is used (performed) and a name of the application used. For example, if the mail application is performed at thirteen nineteen and thirty three seconds, Aug. ______, 20______, “20______/08/______ 13:19:33” is recorded in the column of the date and time, and “mail” is recorded in the column of the name.

Then, the use frequency of the application is calculated based on the use history table. For example, when a lock screen is displayed, the use history for a predetermined period (one week, for example) is read from the use history table, and the application with the highest use frequency is specified based on the use frequency read.

In addition, a performance icon may be displayed on the standby screen, etc. other than the lock screen. In such a case, if the display event that displays the standby screen occurs, the responsivity of the eye-gaze input is improved based on the use frequency.

Furthermore, the use frequency may be taken into consideration when displaying a performance icon on the lock screen etc. For example, a performance icon corresponding to an application with the highest use frequency is displayed on the upper left. In this case, in the user operation forecast processing, the name of the performance icon being displayed on the upper left is acquired without calculating the use frequency.

In other embodiments, the responsivity of the performance icon corresponding to the application having the use frequency equal to or more that a predetermined value may be improved. For example, when the use frequencies of the mail application and the map application are equal to or more than the predetermined value, the responsivity of each of the performance icon corresponding to each of the mail application and the map application is improved.

In the following, the user operation forecast processing and the responsivity improvement processing in the specific example 3 will be described in detail using a memory map of the RAM 56 and flowcharts of the specific example 3. In addition, about the same processing as the specific example 1, by applying the same step numbers, a detailed description will be omitted.

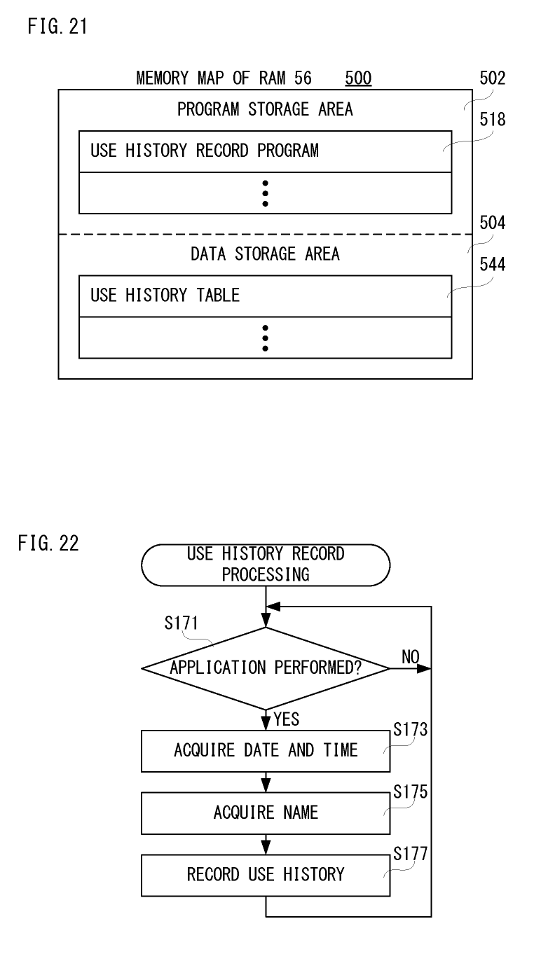

With reference to FIG. 21, the program storage area 502 of the RAM 56 is further stored with a use history record program 518 for recording a use history of the user. Furthermore, in the data storage area 504 of the RAM 56, a use history table 544 of a format shown in FIG. 20, for example is further stored. In addition, since other programs and other data are the same as those of the memory map shown in FIG. 8, a detailed description is omitted.

FIG. 22 is a detailed flowchart of use history record processing. The use history record processing is started if the power supply of the mobile phone 10 is turned on. The processor 40 determines whether an application is performed in a step S171. For example, it is determined whether an operation for performing an application is performed. If “NO” is determined in the step S171, that is, if an application is not performed, the processor 40 repeats the processing of the step S171. On the other hand, if “YES” is determined in the step S171, that is, if an application is performed, the processor 40 acquires the date and time in a step S173, and acquires an application name in a step S175. That is, if an application is performed, the date and time that the application is performed and the name of application are acquired. In addition, the date and time is acquired using the time information that the RTC 40a outputs.

Subsequently, the processor 40 records a use history in a step S177. That is, the processor 40 records the date and time and the name of application acquired in the above-mentioned steps S173 and S175 in the use history table 544 while being associated with each other. In addition, after the processing of step S177 is ended, the processor 40 returns to the processing of the step S171. Furthermore, the processor 40 performing the processing of the step S177 functions as a record module.

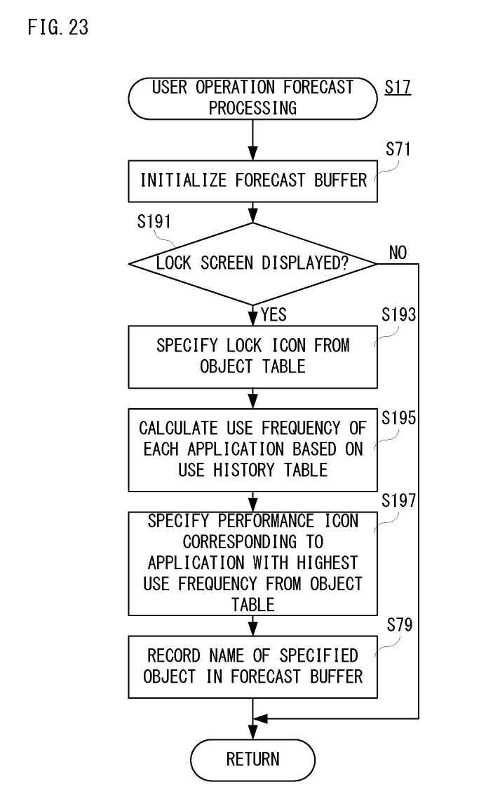

FIG. 23 is a detailed flowchart of the user operation forecast processing of the specific example 3. If the user operation forecast processing is performed in the step S17 of the eye-gaze input processing, the processor 40 initializes the forecast buffer 532 in the step S71.

Subsequently, the processor 40 determines, in a step S191, whether the lock screen is displayed. That is, the processor 40 determines whether a display event of the lock screen occurs. If “NO” is determined in the step S191, that is, if an event occurred is not a display event of the lock screen, the processor 40 terminates the user operation forecast processing, and returns to the eye-gaze input processing.

if “YES” is determined in the step S191, that is, if a display event of the lock screen occurs, the processor 40 acquires the lock icon RI from the object table in a step S193. Subsequently, the processor 40 calculates the use frequency of each application based on the use history table 544 in a step S195. For example, the use history table 544 is read and the use frequency for each name of application recorded is calculated. Subsequently, the processor 40 specifies a performance icon corresponding to an application with the highest use frequency from the object table in a step S197. In a case of the use history table 544 of a format shown in FIG. 20, for example, it is determined that the application with the highest use frequency is the mail application. Therefore, the mail icon 110 corresponding to the mail application is specified from the object table in the step S197. In addition, the processor 40 performing the processing of the step S197 functions as a third forecast module.

Subsequently, the processor 40 records the name of the object that is specified in the forecast buffer 532 in a step S79. Here, the lock icon RI and the mail icon 110 are recorded in the forecast buffer 532. Then, after the processing of step S79 is ended, the processor 40 terminates the user operation forecast processing, and returns to the eye-gaze input processing.

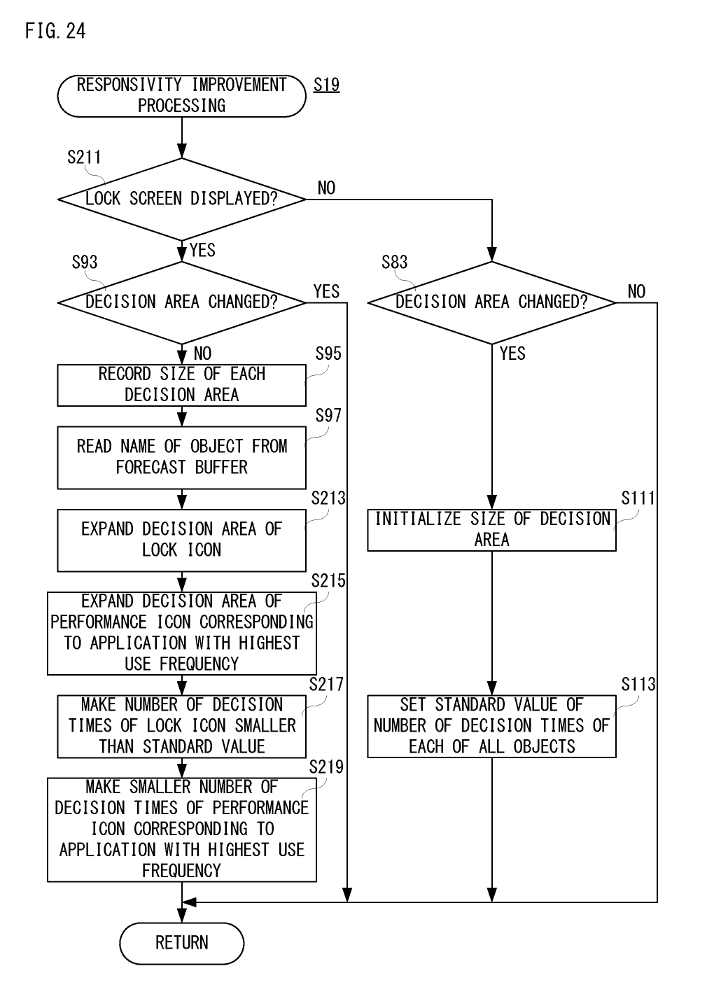

FIG. 24 is a detailed flowchart of the responsivity improvement processing of the specific example 3. If the responsivity improvement processing is performed in the step S19 of the eye-gaze input processing, the processor 40 determines, in a step S211, whether the lock screen is displayed. That is, the processor 40 determines whether the performance icons that a plurality of applications can be performed are displayed.

If “YES” is determined in the step S211, that is, if the lock screen is displayed, the processor 40 determines, in the step S93, whether the decision area has been changed. If “YES” is determined in the step S93, that is, if the decision area has been changed, the processor 40 terminates the responsivity improvement processing, and returns to the eye-gaze input processing. If “NO” is determined at that step S93, that is, if the decision area has not been changed, the processor 40 records the size of each decision area in the step S95.

Subsequently, the processor 40 reads the name of object from the forecast buffer 532 in the step S97. Here, the lock icon RI and the name of the performance icon corresponding to the application with the highest use frequency are read from the forecast buffer 532.

Subsequently, the processor 40 expands the decision area of the lock icon RI in a step S213, and expands the decision area of the performance icon corresponding to the application with the highest use frequency in a step S215. For example, based on the name of the object read from the forecast buffer 532, the processor 40 expands the decision area of the lock icon RI and the mail icon 110.

Subsequently, the processor 40 makes the number of decision times of the lock icon RI smaller than a standard value in a step S217, and makes the number of decision times of the performance icon corresponding to the application with the highest use frequency smaller than a standard value in a step S219. In a case of a state shown in FIG. 19(B), for example, the number of decision times corresponding to each of the lock icon RI and the mail icon 110 is made smaller than the standard value. Then, if the processing of step S219 is ended, the processor 40 terminates the responsivity improvement processing, and returns to the eye-gaze input processing.

In addition, the processor 40 performing the processing of the step S215 and step S219 functions as a third improvement module.

Furthermore, if “NO” is determined in the step S211, that is, if the lock screen is not displayed, the processor 40 determines, in the step S83, whether the decision area has been changed. If “NO” is determined in the step S83, that is, if the decision area has not been changed, the processor 40 terminates the responsivity improvement processing, and returns to the eye-gaze input processing. If “YES” is determined in the step S83, that is, if the decision area has been changed, the processor 40 initializes the size of the decision area in the step S111, and sets the standard value to the number of decision times of each of all the objects in the step S113. That is, the responsivity of the eye-gaze input of each object is returned to the original state.

Then, after the processing of step S113 is ended, the processor 40 terminates the responsivity improvement processing, and returns to the eye-gaze input processing.

In addition, in the specific example 1 to the specific example 3, the processor 40 performing the processing of the steps S99, S101, S153, S213 and S215 functions as an expansion module. Furthermore, the processor 40 performing the processing of steps S105, S107, S155, S217 and S219 functions as a number of decision times change module.

Furthermore, the specific example 1 to the specific example 3 may be combined arbitrarily. For example, if two or more events occur at approximately the same time, the responsivity of the object corresponding to an event among them may be improved, or the responsivity of the object corresponding to each of the events may be improved. Furthermore, in a case where the responsivity of only the object corresponding to one of the events is improved, a priority is set in advance for each event, and an event that the responsivity is to be improved is determined based on the priority. Furthermore, since other combinations can be estimated easily, a detailed description is omitted here.

In addition, the user operation forecast processing and the responsivity improvement processing may be performed in parallel to the eye-gaze input processing as not subroutines of the eye-gaze input processing.

In other embodiments, in order to increase the detection accuracy of the distance from the mobile phone 10 to the user, the proximity sensor 34 may be provided to be adjacent to the infrared LED 30 and the infrared camera 32. Furthermore, in other embodiments, the infrared LED 30 and the infrared camera 32 may be provided to be adjacent to the proximity sensor 34.

In other embodiments, instead of the proximity sensor 34, the proximity of the user face to the mobile phone 10 may be detected using the infrared LED 30 and the infrared camera 32. Specifically, if the eye-gaze input processing is started, the infrared LED 30 is made to weak-emit, and a light reception level of the infrared camera 32 is measured. When the light reception level is equal to or more than a threshold value B, it is determined that the user face exists within a range that the infrared ray that is output from the infrared LED 30 affects the user eye, and the processor 40 terminates the eye-gaze input detection processing. On the other hand, if the light reception level is less than the threshold value B, the infrared LED 30 is made to normal-emit, and as mentioned above, an eye-gaze input of the user is detected. In addition, the light reception level of the infrared camera 32 is calculated based on a shutter speed and an amplifier gain value. For example, when an illuminance is high, the shutter speed becomes quick and the amplifier gain value becomes low. On the other hand, when the illuminance is low, the shutter speed becomes slow and the amplifier gain value becomes high.

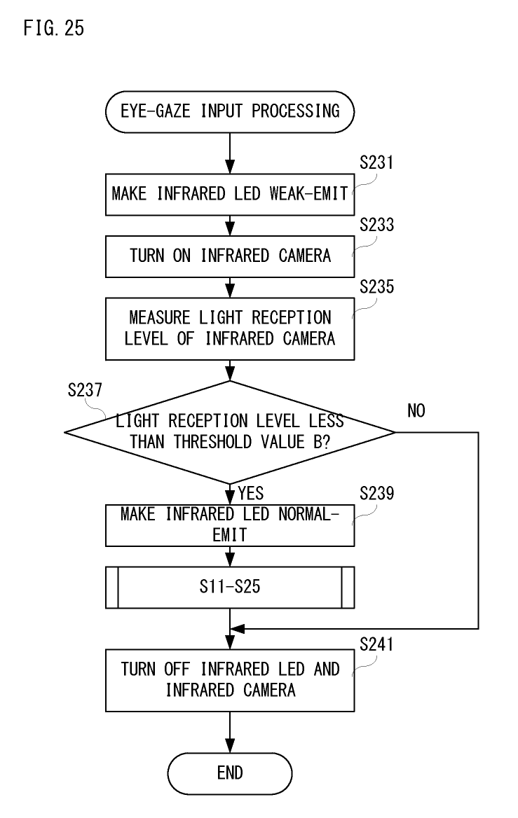

In the following, the eye-gaze input processing of such an embodiment will be described in detail using a flowchart thereof. With reference to FIG. 25, if the eye-gaze input processing of the embodiment is performed, the processor 40 makes the infrared LED 30 weak-emit in a step S231, and turns on the power supply of the infrared camera 32 in a step S233. Subsequently, the processor 40 measures the light reception level of the infrared camera 32 in a step S235. That is, the reception level of the infrared camera 32 is calculated based on the shutter speed and the amplifier gain value of the infrared camera 32.

Subsequently, the processor 40 determines, in a step S237, whether the light reception level is less than a threshold value. That is, like the step S3, it is determined whether the user face exists in the range that the infrared ray that is output from the infrared LED 30 affects the user eye. If “NO” is determined in the step S237, that is, if the light reception level is equal to or more than the threshold value B, the processor 40 proceeds to processing of a step S241. Then, the processor 40 turns off the infrared LED 30 and the infrared camera 32 in the step S241, and terminates the eye-gaze input processing.

On the other hand, if “YES” is determined in the step S237, that is, if the light reception level is less than the threshold value B, the processor 40 renders the infrared LED 30 into a state of normal-emit in a step S239. Subsequently, after the processing of the steps S11-S25 is performed and thus an eye-gaze input of the user is detected, the processor 40 proceeds to processing of the step S241. In the step S241, as mentioned above, the infrared LED 30 and the infrared camera 32 are turned off. That is, since the eye-gaze input is detected, the power supply of the infrared LED 30 and the infrared camera 32 is turned off. Then, if the processing of the step S241 is ended, the processor 40 terminates the eye-gaze input processing.

Furthermore, the decision area may be expanded by taking positions of surrounding objects into consideration. For example, when expanding a decision area of an arbitrary object that another object is displayed on a left side and no other object is displayed on a right side, the decision area is expanded such that a right side becomes larger than a left side.

Although a case where the processing of the processor is performed by an eye-gaze operation is described in this embodiment, it is needless to say that the key operation, the touch operation and the eye-gaze operation may be combined. However, in other embodiments, the key operation and the touch operation may not be received when the processing by the eye-gaze operation is performed.

Although a case where the eye-gaze operation is possible in this embodiment, in fact, there are a case where the eye-gaze operation (eye-gaze input) is possible and a case not possible. The case where the eye-gaze operation is possible is the time that an application that is set in advance possible to perform the eye-gaze operation, for example. As an example of such an application is the digital book application, the mail application, etc. can be cited. On the other hand, the case where the eye-gaze operation is not possible is the time that an application that is set in advance impossible to perform the eye-gaze operation, for example. As an example of such application, the telephone function can be cited. Furthermore, if the eye-gaze operation is possible, a message or image (icon) to that effect may be displayed. When the eye-gaze operation is being performed, a message or image that the eye-gaze input can be received or that the eye-gaze operation is being performed may be displayed. If performing such display, the user can recognize that the eye-gaze operation is possible and that the eye-gaze input is being received.

Furthermore, if the mobile phone 10 has an acceleration sensor or a gyroscope sensor, validity/invalidity of the eye-gaze operation may be switched according to an orientation of the mobile phone 10.

In other embodiments, an infrared cut filter (low pass filter) that reduces (cuts) a light of the infrared wavelength but a light of the wavelength of R, G and B is made to be received better may be provided on a color camera that constitutes the infrared camera 32. In a case of the infrared camera 32 that is provided with the infrared cut filter, a sensitivity of the light of the infrared wavelength may be enhanced. Furthermore, it may be constructed such that the infrared cut filter is attachable to or detachable from the infrared camera 32.

Programs used in the above-described embodiments may be stored in an HDD of the server for data distribution, and distributed to the mobile phone 10 via the network. The plurality of programs may be stored in a storage medium such as an optical disk of CD, DVD, BD or the like, a USB memory, a memory card, etc. and then, such the storage medium may be sold or distributed. In a case that the programs downloaded via the above-described server or storage medium are installed to an electronic apparatus having the structure equal to the structure of the embodiment, it is possible to obtain advantages equal to advantages according to the embodiment.

The specific numerical values mentioned in this specification are only examples, and changeable properly in accordance with the change of product specifications.

It should be noted that reference numerals inside the parentheses and the supplements show one example of a corresponding relationship with the embodiments described above for easy understanding of the invention, and do not limit the invention.

An embodiment is an electronic apparatus that has a display module operable to display a plurality of objects, and detects an eye-gaze input to the plurality of objects, and performs an operation relevant to an object that the eye-gaze input is detected, characterized by comprising: a forecast module operable to forecast a next user operation when an event occurs; and an improvement module operable to improve responsivity of the eye-gaze input to the object for performing the next user operation that is forecasted by the forecast module.

In this embodiment, the electronic apparatus (10: reference numeral exemplifying a portion or module corresponding in the embodiment, and so forth) is displayed with information of the electronic apparatus and a plurality of objects for performing applications etc. on its display (14). Furthermore, the electronic apparatus can detect an eye-gaze input, and if an eye-gaze input is performed to an arbitrary object, performs an operation relevant to the arbitrary object. If an event that a screen is changed, that a notification from a server etc. is received or that an application starts occurs, the forecast module (40, S17) forecasts a next user operation corresponding to the event occurred. If the next user operation is forecast, the improvement module (40, S19) improves the responsivity of an eye-gaze input to the object for performing such a user operation.

According to this embodiment, since the responsivity of an eye-gaze input to an object is improved corresponding to the next user operation, the operability of an eye-gaze input can be improved. Furthermore, since the operating time of the eye-gaze input is shortened if the operability of the eye-gaze input is improved, the electronic apparatus can detect the eye-gaze input with low power consumption.

In a further embodiment, decision areas for detecting an eye-gaze input are corresponding to the plurality of objects, and the improvement module includes an expansion module operable to expand the decision area corresponding to the object for performing the next user operation when the next user operation is forecasted by the forecast module.

in the further embodiment, the decision area for detecting the eye-gaze input is corresponding to each of the objects, and when a position of the eye-gaze input is included in the decision area, an operation relevant to that object is performed. The expansion module (40, S99, S101, S153, S213, S215) expands the decision area corresponding to the object for performing the user operation if the user operation is forecasted.

According to the further embodiment, if the decision area is expanded, a range that receives the eye-gaze input of the user becomes large, and therefore, the eye-gaze input to the object becomes easy to be received.

In a still further embodiment, numbers of decision times for detecting the eye-gaze input are corresponding to the plurality of objects, and the still further embodiment further comprises a first detection module operable to detect a point of gaze in the eye-gaze input; a count module operable to count a number of times when a position of the point of gaze that is detected by the first detection module corresponds to a last position; and a second detection module operable to detect an eye-gaze input to the object when the number of times that is counted by the count module corresponds to the number of decision times, wherein the improvement module further comprises a number of decision times change module operable to make the number of decision times corresponding to the object for performing the next user operation smaller than a standard value when the next user operation is forecasted by the forecast module.

In the still further embodiment, the number of decision times for detecting an eye-gaze input is corresponding to each of the objects. The first detection module (40, S43) detects the point of gaze when the user is gazing at the display module. When the point of gaze that is detected by the first detection module is the same position as that of the last time, the count module (40, S49) counts the number of times. The second detection module (40, S59) detects the eye-gaze input to the object when the number of times that the point of gaze of the user is detected in the same position corresponds to the number of decision times. The number of decision times change module (40, S105, S107, S155, S217, S219) makes smaller than the standard value the number of decision times corresponding to the object for performing the user operation if the user operation is forecasted.

According to the still further embodiment, it is possible to shorten the time until the eye-gaze input is decided by making the number of decision times of the object small.

In a yes further embodiment, the improvement module is operable to change a display manner of the object for performing the next user operation when the next user operation is forecasted by the forecast module.

In the yet further embodiment, as for the object for performing the user operation, when the next user operation is forecasted, the display manner such as a size and a color, for example is changed.

According to the yet further embodiment, it is possible to improve the operability of an eye-gaze input by guiding an eye-gaze of the user.

In a yet still further embodiment, the display module is operable to display a notification object when there is a notification by an application, and the forecast module includes a first forecast module operable to forecast a user operation for performing an application relevant to the notification object when the notification object is displayed, and the improvement module includes a first improvement module operable to improve the responsivity of an eye-gaze input to the notification object.

In the yet still further embodiment, the notification object (96) is displayed on the display module if a new-arrival mail is received by a mail application, for example. The first forecast module (40, S75) forecasts the user operation of performing the mail application if the new-arrival mail is received, for example and the notification object is displayed. Then, the first improvement module (40, S99, S105) improves the responsivity of an eye-gaze input to the notification object.

According to the yet still further embodiment, if an event that displays the notification icon occurs, it is possible to make notified content easy to confirm.

In a further embodiment, the display modules is operable to display, when an application in which display content can be scrolled is performed, a scroll bar corresponding to a display position, and the forecast module includes a second forecast module operable to forecast a user operation for terminating an application being performed when the scroll bar reaches a last position, and the improvement module includes a second improvement module operable to improve the responsivity of an eye-gaze input to an object that terminates the application being performed.

In the further embodiment, the scroll bar (94c) is displayed on the display module if an application such as a digital book application that can scroll the display content is performed, for example. The second forecast module (40, S77) forecasts the user operation for terminating the application being performed if the content currently displayed is displayed to the last and the scroll bar reaches the last position. The second improvement module (40, S101 S107) improves the responsivity of an eye-gaze input to the object for terminating the digital book application being performed, for example.

According to the further embodiment, if the display content is scrolled to the last, it is possible to make the application being performed easy to terminate.

A still further embodiment further comprises a record module operable to record a use history of a plurality of applications, and the forecast module includes a third forecast module operable to forecast a user operation for performing an application with a high use frequency when a specific screen including performance objects by which the plurality of applications can be performed the plurality of applications are displayed, and the improvement module includes a third improvement module operable to improve the responsivity of an eye-gaze input to a performance object for performing the application with a high use frequency based on the use history.

In the still further embodiment, the record module (40, S177) records the use history of the application that is performed by the electronic apparatus. The third forecast module (40, S197) forecasts the user operation of performing an application with high use frequency if a lock screen that the performance objects capable of performing a plurality of applications, for example is displayed. The third improvement module (40, S215, S219) improves the responsivity of the eye-gaze input of the performance object relevant to the application that the use frequency is the highest, for example.

According to the still further embodiment, if the screen that can perform the applications is displayed, based on the use history, it is possible to render in a state where the application is easy to perform.

The other embodiment is an eye-gaze input method in an electronic apparatus (10) that has a display module (14) operable to display a plurality of objects, and detects an eye-gaze input to the plurality of objects, and performs an operation relevant to an object that the eye-gaze input is detected, comprising steps of: forecasting (S17) a next user operation when an event occurs; and improving (S19) responsivity of the eye-gaze input to the object for performing the next user operation that is forecasted by the forecasting step.

According to also the other embodiment, since the responsivity of an eye-gaze input to an object is improved corresponding to the next user operation, the operability of an eye-gaze input can be improved. Furthermore, since the operating time of the eye-gaze input is shortened if the operability of the eye-gaze input is improved, the electronic apparatus can detect the eye-gaze input with low power consumption.

Although the present invention has been described and illustrated in detail, it is clearly understood that the same is by way of illustration and example only and is not to be taken by way of limitation, the spirit and scope of the present invention being limited only by the terms of the appended claims.

### DESCRIPTION OF NUMERALS

10—mobile phone

14—display

16—touch panel

30—infrared LED

32—infrared camera

34—proximity sensor

40—processor

50—input device

54—flash memory

56—RAM

60—LED driver

62—imaged image processing circuit

1. An electronic apparatus that has a display module operable to display a plurality of objects, and detects an eye-gaze input to the plurality of objects, and performs an operation relevant to an object that the eye-gaze input is detected, comprising;
a forecast module operable to forecast a next user operation when an event occurs; and
an improvement module operable to improve responsivity of the eye-gaze input to the object for performing the next user operation that is forecasted by the forecast module.

2. The electronic apparatus according to claim 1, wherein decision areas for detecting an eye-gaze input are corresponding to the plurality of objects, and
the improvement module includes an expansion module operable to expand the decision area corresponding to the object for performing the next user operation when the next user operation is forecasted by the forecast module.

3. The electronic apparatus according to claim 1, wherein numbers of decision times for detecting the eye-gaze input are corresponding to the plurality of objects, further comprising:
a first detection module operable to detect a point of gaze in the eye-gaze input;
a count module operable to count a number of times when a position of the point of gaze that is detected by the first detection module corresponds to a last position; and
a second detection module operable to detect an eye-gaze input to the object when the number of times that is counted by the count module corresponds to the number of decision times,
wherein the improvement module further comprises a number of decision times change module operable to make the number of decision times corresponding to the object for performing the next user operation smaller than a standard value when the next user operation is forecasted by the forecast module.

4. The electronic apparatus according to claim 1, wherein the improvement module is operable to change a display manner of the object for performing the next user operation when the next user operation is forecasted by the forecast module.

5. The electronic apparatus according to claim 1, wherein the display module is operable to display a notification object when there is a notification by an application, and
the forecast module includes a first forecast module operable to forecast a user operation for performing an application relevant to the notification object when the notification object is displayed, and
the improvement module includes a first improvement module operable to improve the responsivity of an eye-gaze input to the notification object.

6. The electronic apparatus according to claim 1, wherein the display modules is operable to display, when an application in which display content can be scrolled is performed, a scroll bar corresponding to a display position, and
the forecast module includes a second forecast module operable to forecast a user operation for terminating an application being performed when the scroll bar reaches a last position, and
the improvement module includes a second improvement module operable to improve the responsivity of an eye-gaze input to an object that terminates the application being performed.

7. The electronic apparatus according to claim 1, further comprising a record module operable to record a use history of a plurality of applications,
wherein the forecast module includes a third forecast module operable to forecast a user operation for performing an application with a high use frequency when a specific screen including performance objects by which the plurality of applications can be performed the plurality of applications are displayed, and
the improvement module includes a third improvement module operable to improve the responsivity of an eye-gaze input to a performance object for performing the application with a high use frequency based on the use history.

8. An eye-gaze input method in an electronic apparatus that has a display module operable to display a plurality of objects, and detects an eye-gaze input to the plurality of objects, and performs an operation relevant to an object that the eye-gaze input is detected, comprising steps of:
forecasting a next user operation when an event occurs; and
improving responsivity of the eye-gaze input to the object for performing the next user operation that is forecasted by the forecasting step.
